(19) United States
(12) Patent Application Publication
(10) Pub. No.: US 2009/0006471 A1
(43) Pub. Date: Jan. 1, 2009

(54) Exposing Specific Metadata in Digital Images

(75) Inventors: Cyra S. Richardson, Bellevue, WA (US); Peter A. Gurevich, Woodinville, WA (US); Saurabh D. Mehta, Redmond, WA (US)

Correspondence Address: LEE & HAYES PLLC, 601 W Riverside Avenue, Suite 1400, SPOKANE, WA, 99201, US

(73) Assignee: Microsoft Corporation, Redmond, WA (US)

(21) Appl. No.: 11/771,580

(22) Filed: Jun. 29, 2007

(51) Int. Cl. G06F 17/30; G06F 17/00

(52) U.S. Cl. 707/104.1; 707/104.1; 707/E17.009

(57) ABSTRACT

Specific metadata exposure with digital images involves making image metadata values associated with metadata type identification tags accessible via an application programming interface (API). In an example embodiment, a browser exposes an image metadata API that may be called with reference to a particular metadata type identification tag. The browser ascertains a particular image metadata value that is associated with the particular metadata type identification tag from image metadata of a targeted image item. When the particular image metadata value is returned to a caller of the image metadata API, the caller may consume or present the particular image metadata value in any manner.

### BACKGROUND

Digital images from digital cameras and other sources are proliferating over the internet. They are being stored at different locations as well as being transferred to and from different devices. Digital images are also being shared in a variety of manners. A multitude of programs and internet-based services exist to facilitate the use and enjoyment of digital images in these various situations. However, such programs and internet-based services fail to fully exploit the potential of having images in digital form.

### SUMMARY

Specific metadata exposure with digital images involves making image metadata values associated with metadata type identification tags accessible via an application programming interface (API). In an example embodiment, a browser exposes an image metadata API that may be called with reference to a particular metadata type identification tag. The browser ascertains a particular image metadata value that is associated with the particular metadata type identification tag from image metadata of a targeted image item. In another example embodiment, the browser causes the ascertained particular image metadata value to be presented in a browser window along with image data of the targeted image item. In yet another example embodiment, a script makes to a browser an image metadata API call referencing a metadata type identification tag, and the browser returns to the script an ascertained image metadata value that is associated with the metadata type identification tag.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Moreover, other method, system, scheme, apparatus, device, media, procedure, API, arrangement, etc. implementations are described herein.

### BRIEF DESCRIPTION OF THE DRAWINGS

The same numbers are used throughout the drawings to reference like and/or corresponding aspects, features, and components.

FIG. 1 is a block diagram of a browser window illustrating example displayed image and displayed image metadata results for an implementation of specific metadata exposure with digital images.

FIG. 2 is a block diagram of an example environment in which specific metadata exposure for digital images may be implemented in conjunction with a browser and an image item.

FIG. 3 includes a flow diagram that illustrates an example of a method for downloading and displaying a page with a browser.

FIG. 4 is a block diagram of an example image item including image data and image metadata.

FIG. 5 is a block diagram of an example scheme for exposing specific metadata in digital images using an image metadata API of a browser.

FIG. 6 includes a flow diagram that illustrates an example of a method for exposing specific metadata in digital images using a metadata type identification tag.

FIG. 7 is a block diagram of example image metadata API read and write calls and responses thereto that are directed to the mapping association entries of image metadata.

FIG. 8 is a flow diagram that illustrates an example of a method for exposing specific metadata in digital images with mapping association entries and read/write image metadata API calls.

FIG. 9 is a block diagram of an example device that may be used to implement embodiments for exposing specific metadata in digital images.

### DETAILED DESCRIPTION

### Introduction to Exposing Specific Metadata in Digital Images

Existing internet-based digital image services can store multiple images for each of multiple users. These images are stored by a server and are typically accessed by a user with a web browser. In operation, a user through a web browser requests to view a number of images stored by the service at a web server. The web server retrieves the requested images from storage that is associated with the web server.

First, the server identifies the images that the customer wants to view. Second, the server software creates the header (or beginning of) a, e.g., HyperText Markup Language (HTML) page. Third, the server software creates the rest of the HTML page, and it adds each requested image from the image storage. Fourth, in the processes of creating the HTML surrounding each image, the server software typically extracts some of the metadata fields, like keywords, from the image file and adds that metadata as static text to the HTML.

While the resulting web page display can satisfy basic consumer desires to view the image and a limited quantity of image metadata, it has two primary problems. First, the process does not scale well at the server. For an internet-based service having millions of customers with thousands or even tens of thousands of images apiece, the server can be required to perform billions of reads. A system in which the server performs processing (as opposed to primarily storage) has to scale in relationship to the number of users, which is less cost effective than a system in which the processing is performed on the client. Secondly, this approach reduces the flexibility offered to a web page developer when designing an image-focused web page display. Specifically, the interactive capabilities offered to the user of the web browser at a client device with respect to the displayed web page are extremely limited. For example, the user cannot ask the web browser to display different image metadata or to change the image metadata without a complete round trip back to the server. That round trip may require the server to re-generate the entire page with the requested metadata or may require the server to parse the image metadata and re-send the parsed image metadata.

In contrast, certain example embodiments as described herein involve a browser that includes an image metadata API. Script that runs on the browser at the client device can make calls to the image metadata API. An image metadata API call can reference a particular image metadata type for a targeted image using an image metadata type identification tag. The image metadata API then ascertains from the targeted image and returns to the script an image metadata value that is associated with the referenced metadata type identification tag. The browser can display the ascertained image metadata value in relation to the actual image in a displayed page. The image metadata API can also enable write API calls that change the image metadata of an image.

### Example Embodiments for Exposing Specific Metadata in Digital Images

### 1: Introduction—Overview and Example Environments

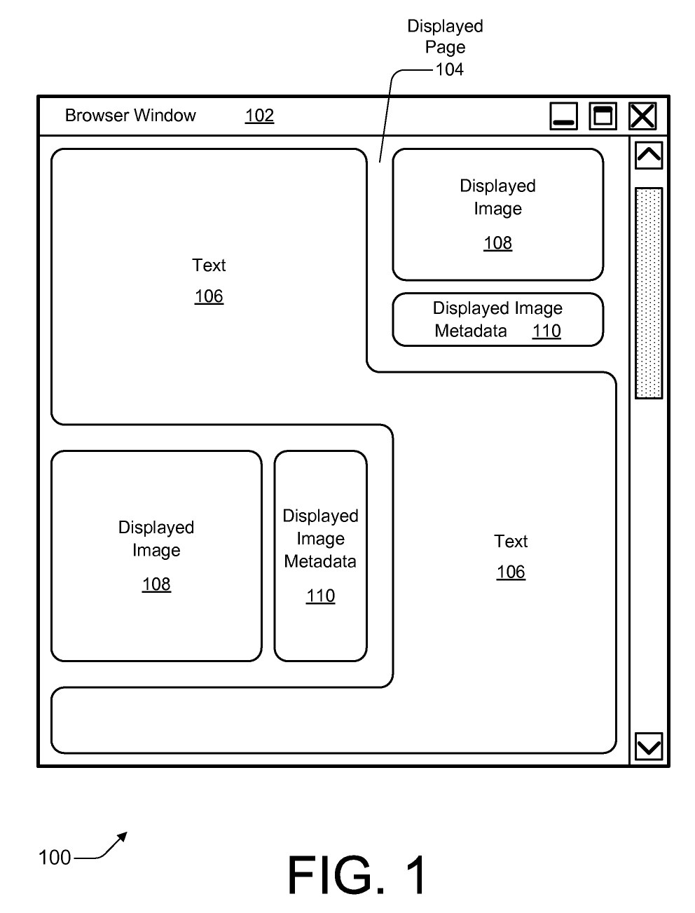

FIG. 1 is a block diagram 100 of a browser window 102 illustrating displayed image 108 and displayed image metadata 110, which are example results for an implementation of specific metadata exposure with digital images. As illustrated, browser window 102 contains a displayed page 104. Displayed page 104 includes text 106, at least one displayed image 108, and at least one displayed image metadata 110.

In an example embodiment, a displayed page 104 includes a displayed image 108 and displayed image metadata 110 that is related thereto. Which particular image metadata value or values that are associated with a given image are presented as part of displayed image metadata 110 is controllable by scripting code that is running within a browser. By way of example only, displayed page 104 may comprise a web page, an intranet page, another network-related page, any page that may be displayed by a browser, some combination thereof, and so forth. More generally, images and selective image metadata data may be presented via displaying on a display screen, via printing on hard copy with a printer, and so forth. A browser window may be manifested in hard copy by borders, framing, edges, etc. around the printed images and printed image metadata data. Examples of image metadata are described herein below.

Although two combinations of displayed image 108 and associated displayed image metadata 110 are explicitly shown within browser window 102 in FIG. 1, fewer or more than two may alternatively be displayed. Also, in addition to below and beside the displayed image 108, displayed image metadata 110 may be positioned elsewhere with respect to its associated displayed image metadata 110. Moreover, image information 108/110 may be displayed in a grid or other pattern, separate from or intertwined with text 106, and so forth. A displayed page 104 may also include other information besides text 106, displayed images 108, and displayed image metadata 110.

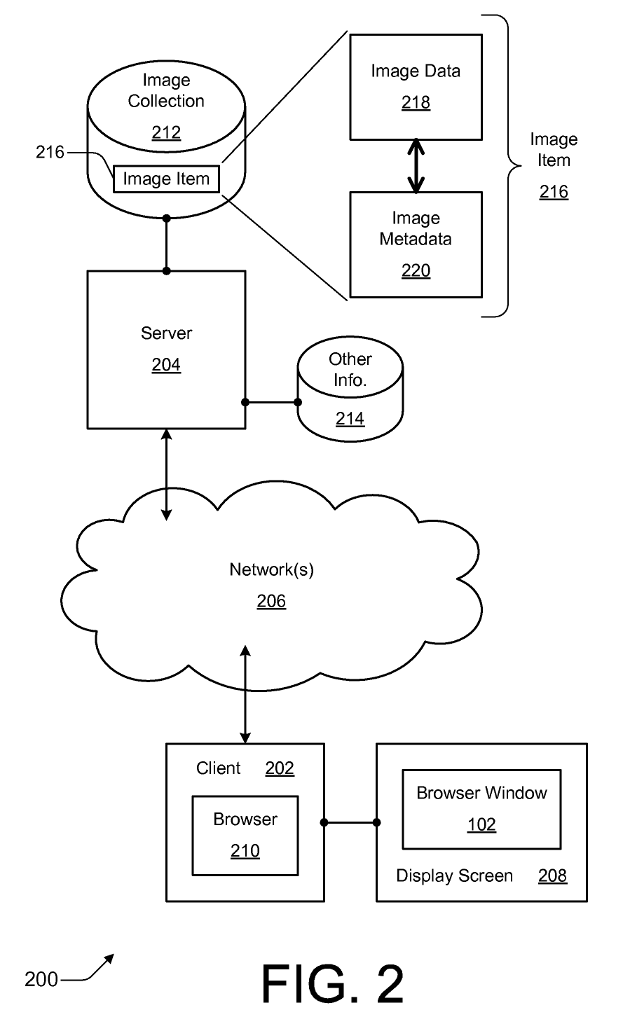

FIG. 2 is a block diagram of an example environment 200 in which specific metadata exposure for digital images may be implemented in conjunction with a browser 210 and an image item 216. As illustrated, environment 200 includes a client 202, a server 204, and one or more networks 206. Client 202 includes a display screen 208, and server 204 includes image collection 212 and other information 214.

In an example embodiment, client 202 and server 204 communicate over network(s) 206. Network(s) 206 may comprise, by way of example but not limitation, one or more of an internet, an intranet, a telephone network, a public network, a private network, a wired network, a wireless network, some combination thereof, and so forth. Communications between client 202 and server 204, such as those described herein below in the context of pages, may be transmitted over network 206.

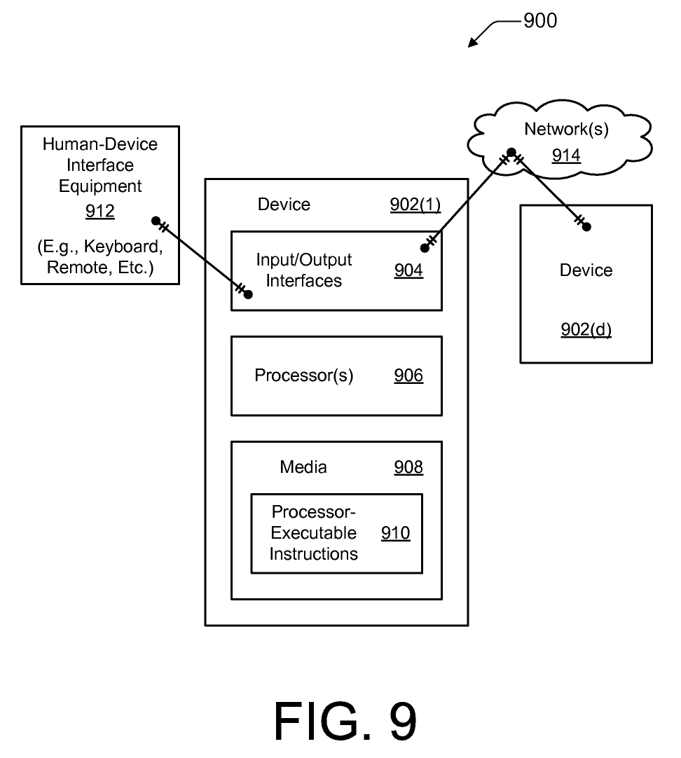

Display screen 208 is coupled to and/or integrated with client 202. Client 202 includes at least one browser 210. Browser 210 produces browser window 102, which is displayed on display screen 208. Client 202 may be realized as a personal computer (e.g., workstation, desktop, notebook, etc.), an entertainment device (e.g., audio/visual player), a television or a set-top box therefor, a personal digital assistant (PDA), a mobile phone or other portable device, a gaming platform, any device that is capable of running a browser 210, some combination thereof, and so forth. An example device implementation that may be used to realize a client 202 and/or a server 204 is described herein below with particular reference to FIG. 9.

Browser 210 may be implemented as a proprietary browser, an open-source browser, and so forth. Browser 210 may be a separate application or it may be embedded in or otherwise be a part of another application, such as an operating system, an internet or other communications suite, and so forth. Examples of current browsers include, but are not limited to, INTERNET EXPLORER from MICROSOFT Corporation, SAFARI from APPLE Inc., MOZILLA FIREFOX, OPERA, KONQUEROR, NETSCAPE, and so forth.

Server 204 is coupled to and/or integrated with image collection 212 and other information 214. Image collection 212 and other information 214 may be implemented as separate collections of information or as a combined collection of information. They may be realized, for example, as one or more databases. These elements 204, 212, and 214 may be configured in any manner. Example configurations include, but are not limited to, at least one web server, a server farm, one or more servers connected to a storage area network (SAN), a server and a locally-attached non-volatile memory unit, some combination thereof, and so forth.

In an example embodiment, information from image collection 212 and/or other information 214 may be served as one or more pages of information. Image collection 212 includes information relating to images. Other information 214 includes non-image-related information, such as text. Image collection 212 includes multiple image items 216. Image items 216 of image collection 212 may be organized in any manner.

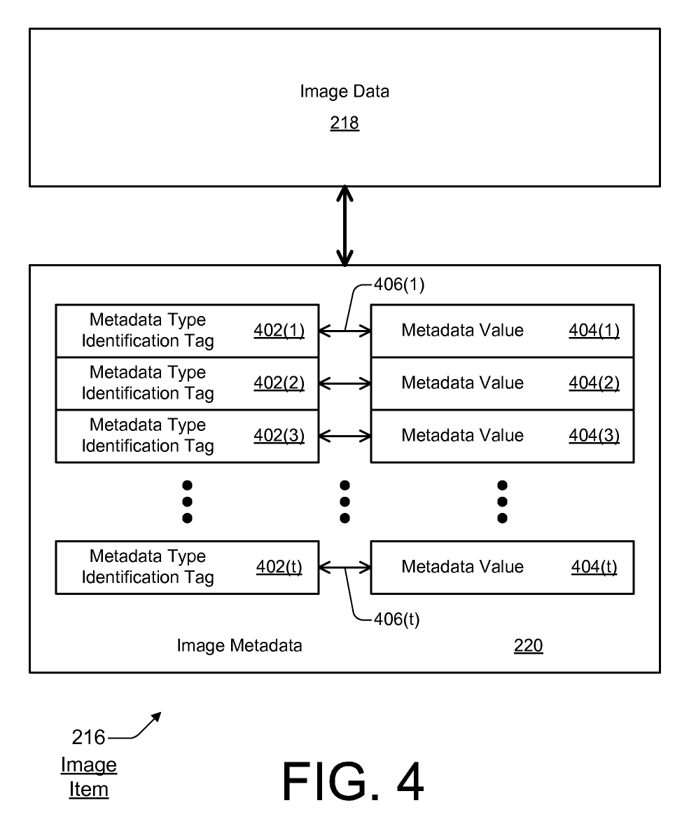

Each image item 216 may include image data 218 and image metadata 220. Image data 218 includes the data to render an image on a display screen. Image metadata 220 is associated with image data 218. Image metadata 220 contains one or more metadata values relating to the associated image data 218. Example metadata types include, but are not limited to, the file name of the image item, the date and/or time of the image data, a size of the image item, a height of the image data, a width of the image data, and so forth. Example aspects and characteristics of image item 216, including an example data structure for image metadata 220, are described further herein below with particular reference to FIG. 4.

In an example general operation, browser 210 at client 202 sends to server 204 over network 206 a request for information. In response, server 204 produces (e.g., constructs, retrieves, etc.) a page using image collection 212 and/or other information 214. The page includes the requested information. The page may be produced in a markup language format. By way of example only, a markup language format may comport with HTML, MICROSOFT HyperText Markup Language (MSHTML), Standard Generalized Markup Language (SGML), Extensible Access Markup Language (XAML), Extensible HTML (XHTML), Extensible Markup Language (XML), and so forth.

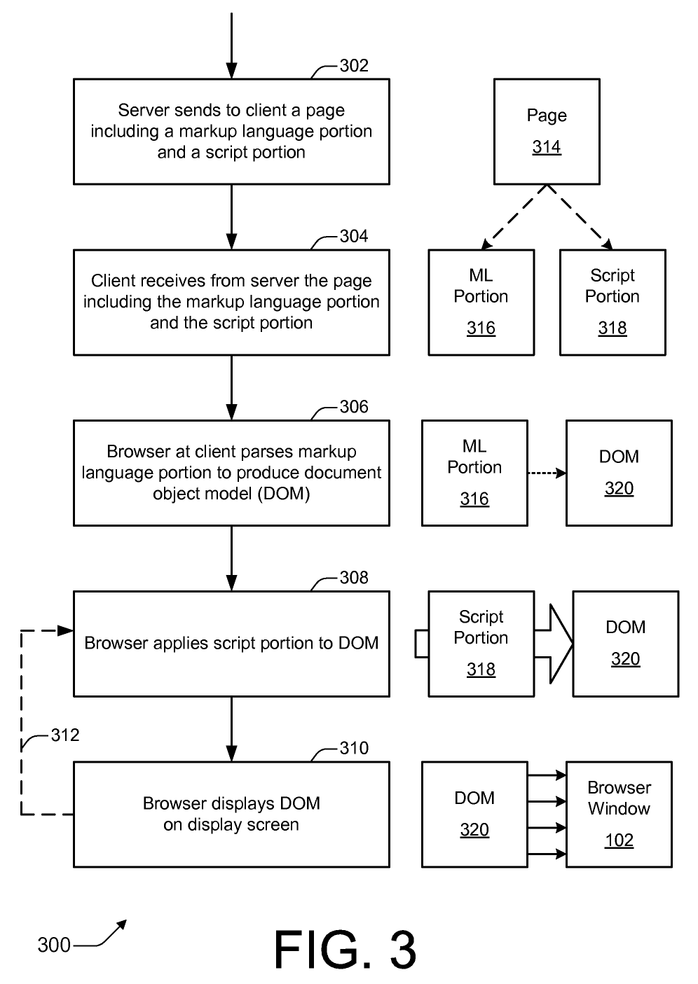

The page is sent from server 204 across network 206 to client 202. Browser 210 at client 202 then processes the page and causes the processed page to be displayed in browser window 102 on display screen 208. The displayed view of the page can be manipulated at client 202 by browser 210 with script coding. In an example embodiment, the page is received from server 204 at client 202 with both a markup language portion and a scripting portion. These page portions and the processing thereof are described further below with particular reference to FIG. 3.

In the drawings, FIGS. 3, 6, and 8 are flow diagrams 300, 600, and 800, respectively. Implementations of flow diagrams 300, 600, and 800 may be realized, for example, as processor-executable instructions. Processor-executable instructions may be embodied as software, firmware, hardware, fixed logic circuitry, some combination thereof, and so forth. The acts of these flow diagrams may be performed in many different environments, by a number of different devices, and/or with a variety of different browser configurations. Hence, although the descriptions of certain blocks and the acts thereof reference other elements that are described herein, they do so by way of example only. The order in which the methods are described is not intended to be construed as a limitation, and any number of the described blocks can be combined, augmented, rearranged, and/or omitted to implement a respective method, or an alternative method that is equivalent thereto.

FIG. 3 includes a flow diagram 300 that illustrates an example of a method for downloading and displaying a page with a browser. Flow diagram 300 includes five (5) blocks 302-310 and a dashed arrow 312. FIG. 3 also includes five (5) other blocks 102 and 314-320 that further illuminate the example method. A server, a client, and a browser perform acts in flow diagram 300. These may correspond to, for example, server 204, client 202, and browser 210, respectively (each of FIG. 2). It should be understood that present and/or future approaches to downloading and displaying a page with a browser may differ from the specific example acts described with reference to flow diagram 300.

In an example embodiment, at block 302, a server sends to a client a page that includes a markup language portion and a script portion. For example, server 204 may send page 314 to client 202. At block 304, the client receives from the server the page that includes the markup language portion and the script portion. For example, client 202 may receive from server 204 a markup language (ML) portion 316 and a script portion 318 of page 314. Script portion 318 can comport with any one or more of many existing or new scripting formats. Example scripting formats include, but are not limited to, JAVASCRIPT, VBSCRIPT, ECMASCRIPT, and so forth.

At block 306, a browser at the client parses the markup language portion to produce a document object model (DOM) for the page. For example, browser 210 at client 202 may parse markup language portion 316 to produce a DOM 320 for page 314. For instance, the markup tags of markup language portion 316 may be transformed into objects of DOM 320.

At block 308, the browser applies the script portion to the DOM. For example, browser 210 may execute scripting code of script portion 318 on DOM 320. This may affect how and/or what parts of page 314 are displayed. At block 310, the browser displays the DOM on a display screen. For example, browser 210 may display DOM 320, as affected by script portion 318, in a browser window 102 on a display screen 208. As indicated by dashed arrow 312, script portion 318 can continuously, repeatedly, and/or occasionally (e.g., in response to user interaction) alter how it is affecting the display of DOM 320 in browser window 102.

### 2: Example Embodiments

Digital images are typically created, stored, and maintained in an image file format in accordance with some digital image standard. Digital image standards can be relatively proprietary, relatively open, and so forth. Example digital image standards include, but are not limited to, those that comport with a Joint Photographic Experts Group (JPEG) specification, a JPEG Interchange Format (JIF) specification, a Portable Network Graphics (PNG) specification, a Tagged Image File (TIF) specification, an Exchangeable Image File (EXIF) standard, HD PHOTO/WINDOWS MEDIA PHOTO from MICROSOFT Corporation, and so forth. Many camera manufacturers and some digital imaging software companies also issue their own digital image standards. Additionally, although two different files may share the same image file format, they may still have different sub-formats for the image metadata encoding. These sub-formats can result when, for example, the files are created with different software and/or devices. Thus, image file formats may also embrace sub-formats as well.

These digital image standards, among other things, specify how digital image metadata is to be configured and/or organized. For example, they can specify a metadata type identification tag that is associated with each type of metadata. Thus, image metadata may include multiple respective metadata type identification tags that are each respectively associated with a metadata value of the metadata type. An example image metadata organization is described herein below with particular reference to FIG. 4.

Example metadata types, which may have corresponding metadata type identification tags, are listed below. However, some digital image standards include different metadata types, fewer total metadata types, more total metadata types, and so forth. For instance, some standards define 10s, some define 100s, and some define 1000s or more of different image metadata types. Metadata type examples include, but are not limited to, camera manufacturer, camera model, compression type, X resolution, Y resolution, time, date, ambient conditions (e.g., lighting), embedded sound, global positioning system (GPS) coordinates, and so forth. Furthermore, metadata types of the various digital image standards can also include user added/provided information such as author, copyright information, one or more keywords, a voice annotation, combinations thereof, and so forth. It should be understood that metadata type refers to a kind of metadata as described above and not necessarily to a variable category.

FIG. 4 is a block diagram of an example image item 216 including image data 218 and image metadata 220. As illustrated, image metadata 220 includes multiple mapping association entries 406 between metadata type identification tags 402 and metadata values 404. Image metadata 220 includes “t” mapping association entries 406(1) . . . 406(t) having metadata type identification tags 402(1) . . . 402(t) and metadata values 404(1) . . . 404(t), respectively. The variable “t” represents some integer.

Specifically, metadata type identification tag 402(1) is associated with image metadata value 404(1). Metadata type identification tag 402(2) is associated with image metadata value 404(2). Metadata type identification tag 402(3) is associated with image metadata value 404 (3). And metadata type identification tag 402(t) is associated with image metadata value 404(t). Image metadata 220 may include any number “t” of mapping association entries 406 from zero, one, two, and so forth.

Thus, in an example embodiment, each mapping association entry 406(x) associates a respective metadata type identification tag 402(x) with a respective metadata value 404(x), with “x” being a generic variable taking on a value for “t”. Metadata type identification tag 402 identifies the meaning of the associated metadata value 404. Metadata type identification tag 402 may be implemented as a name, a number, some other (e.g., alphanumeric) character or combination of characters, and so forth.

For an example embodiment, these metadata type identification tags 402 are defined by the corresponding image file format of the applicable digital image standard of image item 216. The term “tags” may comprise tags, fields, keys, etc. as used in the various standards. Some standards, by way of example only, use one, two, or more characters as a hexadecimal number to represent each metadata type identification tag 402. For instance, a metadata type identification tag 402 of “IF” may be associated with a metadata value 404 representing a metadata type that is the date that image data 218 was acquired. A desired particular image metadata value 404(x) may be extracted from image metadata 220 by referencing or otherwise using the associated particular metadata type identification tag 402(x) of the corresponding mapping entry 406(x).

Different digital image standards specify different metadata types and different total numbers of metadata types. For example, the JIF and PNG standards define on the order of tens of different metadata types. The JPEG and TIF standards define on the order of hundreds of different metadata types. Other standards can also define thousands or more of different metadata types.

Digital image standards also usually define different metadata type identification tags to be associated with the same metadata type. In other words, a metadata type identification tag of “0B3” may be associated with a date metadata type in a first standard, may be associated with a compression ratio metadata type in a second standard, may be undefined in a third standard, and so forth. Thus, a page developer may consult a particular digital image standard to learn what the metadata type identification tag is for a given metadata type for image items comporting with that image file format.

Although these digital image standards can have lengthy, complex documentation, some page developers may prefer to have access to each existing specific metadata type as well as some control over their manipulation. Each specific metadata type may be accessed with reference to the associated specific metadata type identification tag defined in a given digital image standard using an image metadata API that is described herein for certain example embodiments. Thus, even those metadata types that are relatively rarely used in a page and/or browser-based environment can be made accessible for page developers that wish to look up and reference a specific metadata type identification tag.

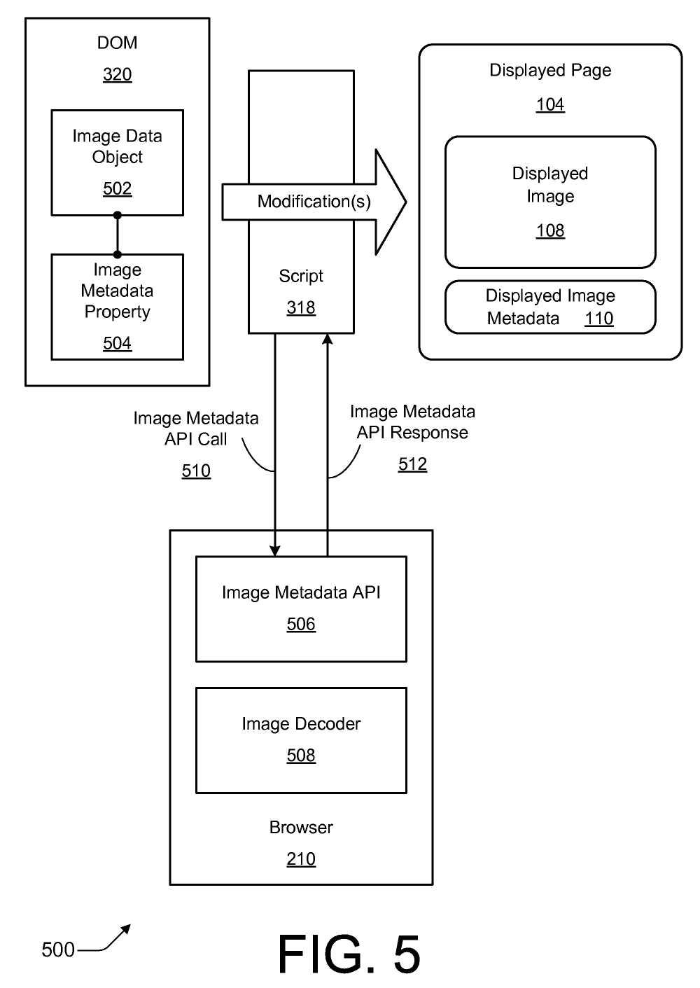

FIG. 5 is a block diagram of an example scheme 500 for exposing specific metadata in digital images using an image metadata API 506 of a browser 210. As illustrated, scheme 500 includes a DOM 320, a script 318, a displayed page 104, and browser 210. DOM 320 includes an image data object 502 and an image metadata property 504. Browser 210 includes image metadata API 506 and image decoder 508. Displayed page 104 includes displayed image 108 and displayed image metadata 110 that is associated therewith.

In an example embodiment, scheme 500 also includes an image metadata API call 510 and an image metadata API response 512. Generally, image metadata API call 510 and image metadata API response 512 enable one or more values of image metadata to be displayed for a particular image under the control of script 318. This API exchange enables script 318 to modify or otherwise affect what image metadata is displayed. Thus, script 318 may affect what image metadata is displayed by way of insertion, addition, deletion, replacement, and so forth. Script 318 may effect such changes by changing markup language portion 316 or DOM 320 directly. Browser 210 can propagate changes to markup language portion 316 to DOM 320 prior to displaying it.

As described above with particular reference to FIG. 3, browser 210 parses a markup language portion 316 of a page 314 to produce DOM 320. This parsing typically produces objects from tagged parts of markup language portion 316. Image data object 502 is produced from and corresponds to image data 218 (of FIG. 2). Image metadata property 504 is produced from and corresponds to image metadata 220. Image metadata property 504 can include the metadata value(s) of image metadata 220.

In an example implementation, image decoder 508 decodes any image items 216 included in markup language portion 316. This usually occurs during the parsing, but it may be performed fully or partially at another time, including in response to an image metadata API call 510. Image metadata API 506 enables script 318 to interact with browser 210, including image decoder 508, so as to make image metadata property 504 accessible to page developers that write script 318.

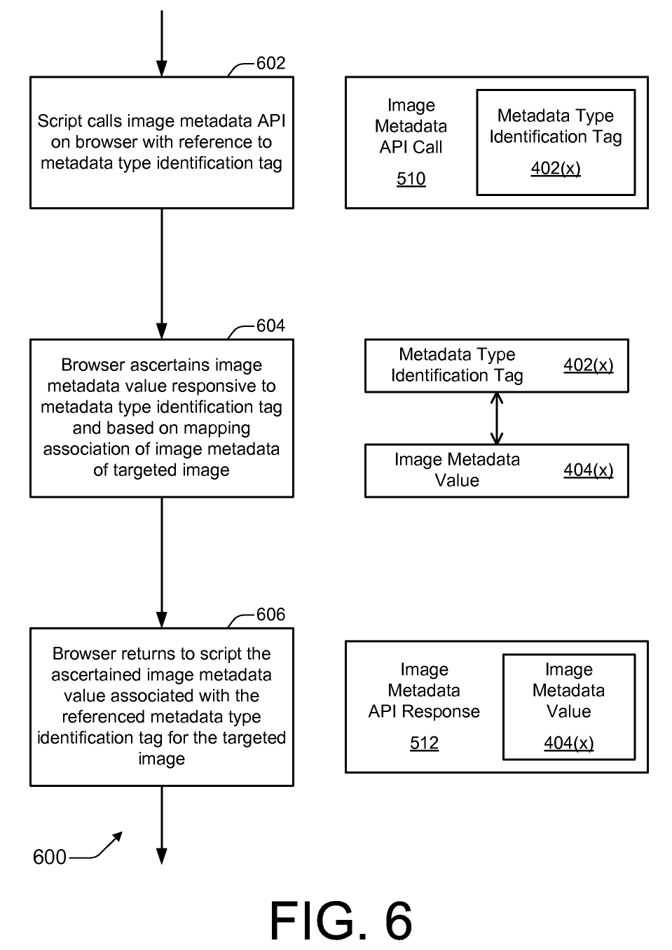

As described above, different digital image standards usually define different metadata type identification tags for each specific metadata type. To provide a page developer with more precise control over the image metadata, the page developer can supply the appropriate metadata type identification tag for the given digital image standard to which the image file format comports based on the image metadata type that the page developer desires. The metadata type identification tag can be referenced (e.g., included) in image metadata API calls 510. Example embodiments are described in further detail herein below with particular reference to FIGS. 6-8.

In operation of an example embodiment, script 318 sends an image metadata API call 510 to image metadata API 506. By way of example only, such an image metadata API call 510 may be formulated similar to: “ImageName.SpecificMetadata.MetadataTypeIdentificationTag(#)”. The ‘ImageName’ portion references a targeted image item 216. The ‘SpecificMetadata’ portion may be a literal that indicates that a specific image metadata type identification tag is being included in the API call. The ‘MetadataTypeIdentificationTag(_)’ portion may be a literal, and the ‘#’ portion represents a desired metadata type identification tag 402.

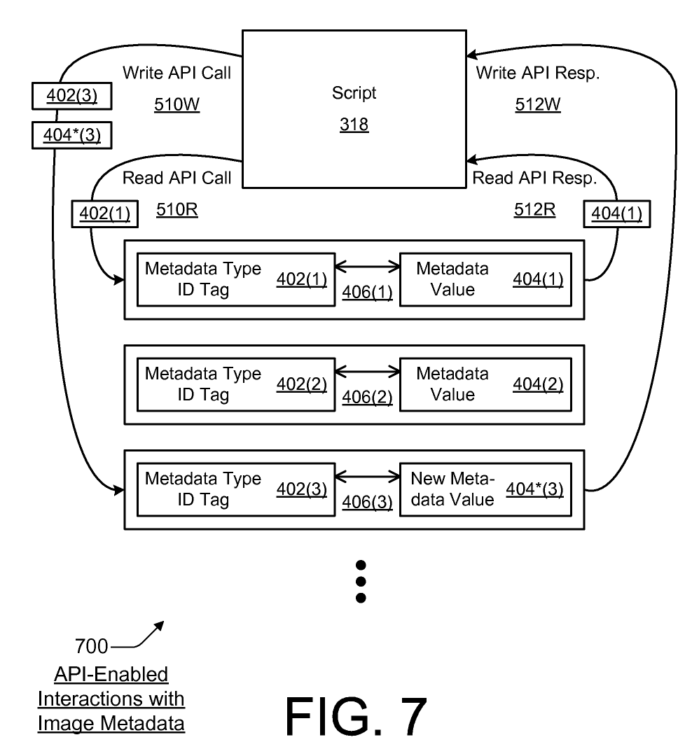

Browser 210, using image decoder 508, ascertains a metadata value that is associated with the metadata type identification tag for the targeted image item. The metadata type identification tag may be referenced in a read API call or a write API call. Example API-enabled read and write interactions with image metadata are described herein below with particular reference to FIG. 7. With scheme 500 of FIG. 5, the ascertained metadata value is returned to script 318 in image metadata API response 512. The returned metadata value may then be displayed as at least part of displayed image metadata 110.

FIG. 6 includes a flow diagram 600 that illustrates an example of a method for exposing specific metadata in digital images using a metadata type identification tag. Flow diagram 600 includes three (3) blocks 602-606. FIG. 6 also includes four (4) other blocks 402(x), 404(x), 510, and 512 that further illuminate the example method. A browser and script code perform acts in flow diagram 600. These may correspond to, for example, browser 210 and script portion 318, respectively (of FIGS. 2, 3, and 5).

In an example embodiment, at block 602, a script calls an image metadata API on a browser with reference to a metadata type identification tag. For example, a script 318 may make to an image metadata API 506 of a browser 210 an image metadata API call 510 referencing a metadata type identification tag 402(x).

At block 604, the browser ascertains an image metadata value responsive to the metadata type identification tag and based on a mapping association entry of the image metadata of the targeted image. For example, browser 210, using image decoder 508, may ascertain an image metadata value 404(x) that is associated with the referenced metadata type identification tag 402(x). This may entail accessing a mapping association entry 406(x), which corresponds to metadata type identification tag 402(x), of image metadata 220 of the targeted image item 216.

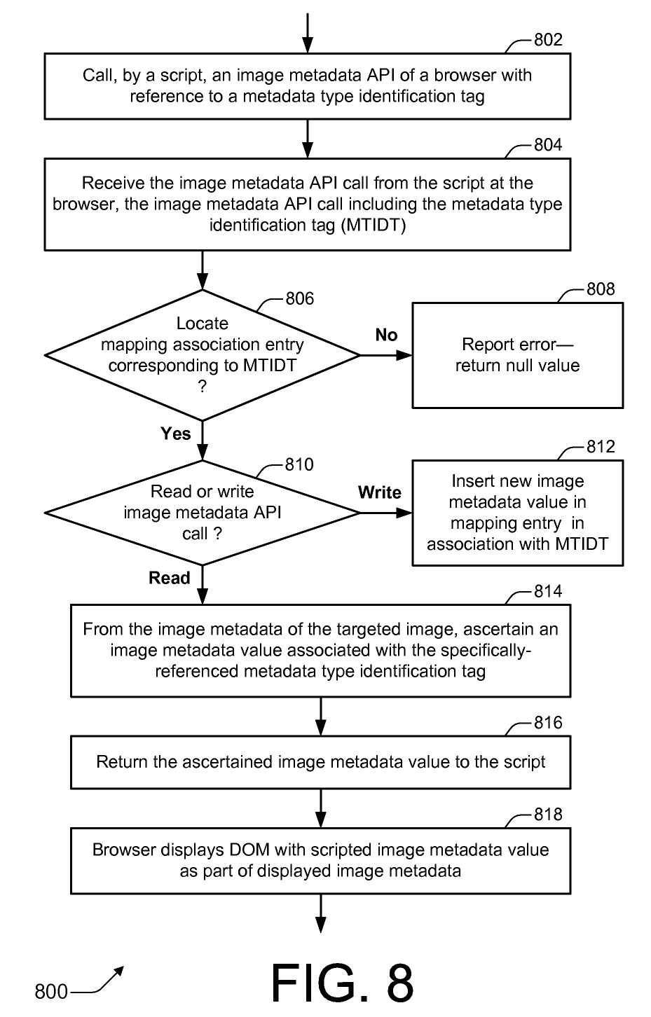

If no match for the referenced metadata type identification tag 402(x) is located in image metadata 220, an error indication, which may include a zero or a null value, is returned to script portion 318. Examples of image metadata ascertainment, as well as failed attempts, are described further herein below with particular reference to FIGS. 7 and 8.

At block 606, the browser returns to the script the ascertained image metadata value that is associated with the referenced metadata type identification tag for the targeted image. For example, browser 210 may send to script 318 an image metadata API response 512 including image metadata value 404(x) for the targeted image item 216. The returned image metadata value 404(x) may then be displayed as part of displayed page 104, such as by being at least a portion of displayed image metadata 110.

FIG. 7 is a block diagram 700 of example image metadata API read and write calls and responses thereto that are directed to the mapping association entries 406 of image metadata. Thus, block diagram 700 illustrates API-enabled read and write interactions with image metadata 220. The image metadata may be currently accessible from a markup language image element, from a DOM image metadata property 504, and so forth.

As illustrated, block diagram 700 includes more than three (as indicated by the ellipses) mapping association entries 406, script 318, a read image metadata API call 510R, a read image metadata API response 512R, a write image metadata API call 510W, and a write image metadata API response 512W. Each respective mapping association entry 406 includes a respective metadata type identification tag 402 and a respective metadata value 404.

An example read API exchange 510R/512R is described below. An example write API exchange 510W/512W is described thereafter. Although not explicitly illustrated in FIG. 7, a browser 210 having an image metadata API 506 may receive the API calls 510R/510W from script 318 and send the API responses 512R/512W to script 318. Thus, browser 210 may perform the accessing, etc. of the image metadata.

In an example reading embodiment, script 318 makes a read image metadata API call 510R including a metadata type identification tag 402(1). Metadata type identification tag 402(1) corresponds to mapping association entry 406(1). Mapping association entry 406(1) contains image metadata value 404(1). Image metadata value 404(1) is therefore associated with metadata type identification tag 402(1). Consequently, a read image metadata API response 512R including image metadata value 404(1) is returned to script portion 318. If no mapping association entry 406(1) corresponding to the referenced metadata type identification tag 402(1) is located, an error message may be returned.

In an example writing embodiment, script 318 makes a write image metadata API call 510W including a metadata type identification tag 402(3) and a new image metadata value 404*(3). Metadata type identification tag 402(3) corresponds to mapping association entry 406(3). Mapping association entry 406(3) also corresponds to the location of image metadata value 404(3), which is an older or out-of-date version thereof. In response to write image metadata API call 510W, browser 210 inserts new image metadata value 404*(3) in association with metadata type identification tag 402(3) at mapping association entry 406(3). Generally, an insertion can entail an addition, a replacement, and so forth. A write image metadata API response 512W confirming the insertion of new image metadata value 404*(3) in response to write image metadata API call 510W may be returned to script portion 318.

By implementing certain example embodiment(s) from one or more of scheme 500 (of FIG. 5), flow diagram 600 (of FIG. 6), and/or API-enabled image metadata interactions 700 (of FIG. 7), image metadata capabilities are expanded. For example, browser users can copy a public image from a web site and acquire the keywords and/or description that the image is tagged with, as well as the other image metadata. Furthermore, the speed of keyword searches on, e.g., image sharing sites may be increased by obviating the need to query keyword information from a heavily-used server across a network.

Also, as described above with particular reference to FIG. 7, the image metadata values may be readable, read-only, writeable, and so forth. For the read/read-only metadata types, the image metadata may be read using a metadata reader. For writeable metadata types, the image metadata may be written to using a metadata writer. Consequently, users of web applications and other applications that can handle markup-language-based files are able to read from and write to image metadata without necessitating server interaction.

FIG. 8 is a flow diagram 800 that illustrates an example of a method for exposing specific metadata in digital images with mapping association entries and read/write image metadata API calls. Flow diagram 800 includes nine (9) blocks 802-818. A browser and a script code perform acts in flow diagram 800. These may correspond to, for example, browser 210 and script portion 318, respectively (of FIGS. 2, 3, 5, and 7).

In an example embodiment, at block 802, a script calls an image metadata API of a browser with reference to a metadata type identification tag. For example, script 318 may send an image metadata API call 510 to image metadata API 506 of browser 210 with a reference to a metadata type identification tag 402(x). At block 804, the browser receives from the script the image metadata API call that includes the metadata type identification tag and pertains to a targeted image. For example, image metadata API 506 of browser 210 may receive from script 318 image metadata API call 510 that includes metadata type identification tag 402(x) and that pertains to a targeted image item 216.

At block 806, it is determined if a mapping association entry corresponding to the referenced metadata type identification tag can be located. For example, browser 210 can determine if a mapping association entry 406(x) corresponding to the received metadata type identification tag 402(x) can be located in image metadata 220. If not, then at block 808 an error is reported to the script, e.g. by returning a zero or null value. For example, browser 210 may send a message (e.g., an image metadata API response 512) including an error indicator that indicates image metadata 220 of the targeted image item 216 does not contain the referenced metadata type identification tag 402(x).

As noted above, the image metadata API of a browser may be write-capable as well as read-capable. So if, on the other hand, a mapping association entry corresponding to the referenced metadata type identification tag is located (at block 806), then at block 810 it is determined if the API call is a read or a write image metadata API call. For example, image metadata API 506 may determine if the received image metadata API call 510 is a read API call 510R or a write API call 510W (of FIG. 7).

If the received call is a write API call, then at block 812 a new image metadata value that is received in the write API call is inserted in association with the referenced metadata type identification tag into the mapping entry corresponding thereto. For example, browser 210 may insert a new image metadata value 404*(x) (of FIG. 7) in association with the received metadata type identification tag 402(x) in the located mapping association entry 406(x). New image metadata value 404*(x) may be received in the initiating write image metadata API call 510W or a subsequent write image metadata API call 510W.

On the other hand, if it is determined (at block 810) that the received image metadata API call is a read API call, then at block 814, from the image metadata of the targeted image, an image metadata value associated with the specifically-referenced metadata type identification tag is ascertained. For example, from image metadata 220 (e.g., of FIGS. 4 and 7) of the targeted image item 216 including from the mapping association entries 406 thereof, an image metadata value 404(x) that is associated with the specifically-referenced metadata type identification tag 402(x) may be ascertained. It may be extracted from the mapping association entry 406(x) corresponding to the specifically-referenced metadata type identification tag 402(x).

At block 816, the ascertained image metadata value is returned to the script. For example, image metadata API 506 may return the ascertained image metadata value 404(x) to script 318 in an image metadata API response 512 (e.g., in a read image metadata API response 512R). At block 818, the browser displays the DOM with the scripted image metadata value as part of displayed image metadata. For example, browser 210 may display DOM 320 with the scripted image metadata value 404(x) being included as part of displayed image metadata 110 for displayed image 108 on a displayed page 104. Those image metadata values 404 of image metadata 220 that are not referenced by way of their associated metadata type identification tags 402 in one or more image metadata API calls 510 may be excluded from displayed image metadata 110.

### Example Device Implementations for Exposing Specific Metadata in Digital Images

FIG. 9 is a block diagram 900 of an example device 902 that may be used to implement specific metadata exposure with digital images. As illustrated, two devices 902(1) and 902(d) are capable of engaging in communications via network(s) 914, with “d” representing an integer. Although two devices 902 are specifically shown, one or more than two devices 902 may be employed, depending on implementation. Network(s) 914 may be, by way of example but not limitation, an internet, an intranet, an Ethernet, a public network, a private network, a cable network, a digital subscriber line (DSL) network, a telephone network, a Fibre network, a Grid computer network, an avenue to connect to such a network, a wireless network, a mesh network, some combination thereof, and so forth. Alternatively, two devices 902 may be directly connected.

Generally, a device 902 may represent any computer or processing-capable device, such as a server device; a workstation or other general computer device; a data storage repository apparatus; a personal digital assistant (PDA); a mobile phone; a gaming platform; an entertainment device; a router computing node; a mesh or other network node; a wireless access point; some combination thereof; and so forth. As illustrated, device 902 includes one or more input/output (I/O) interfaces 904, at least one processor 906, and one or more media 908. Media 908 include processor-executable instructions 910.

In an example embodiment of device 902, I/O interfaces 904 may include (i) a network interface for communicating across network 914, (ii) a display device interface for displaying information on a display screen, (iii) one or more human-device interfaces, and so forth. Examples of (i) network interfaces include a network card, a modem, one or more ports, a network communications stack, a radio, and so forth. Examples of (ii) display device interfaces include a graphics driver, a graphics card, a hardware or software driver for a screen or monitor, and so forth. Examples of (iii) human-device interfaces include those that communicate by wire or wirelessly to human-device interface equipment 912 (e.g., a keyboard, a remote, a mouse or other graphical pointing device, etc.).

Generally, processor 906 is capable of executing, performing, and/or otherwise effectuating processor-executable instructions, such as processor-executable instructions 910. Media 908 is comprised of one or more processor-accessible media. In other words, media 908 may include processor-executable instructions 910 that are executable by processor 906 to effectuate the performance of functions by device 902. Processor-executable instructions may be embodied as software, firmware, hardware, fixed logic circuitry, some combination thereof, and so forth.

Thus, realizations for specific metadata exposure with digital images may be described in the general context of processor-executable instructions. Generally, processor-executable instructions include routines, programs, applications, coding, modules, protocols, objects, components, metadata and definitions thereof, data structures, application programming interfaces (APIs), etc. that perform and/or enable particular tasks and/or implement particular abstract data types. Processor-executable instructions may be located in separate storage media, executed by different processors, and/or propagated over or extant on various transmission media.

Processor(s) 906 may be implemented using any applicable processing-capable technology, and one may be realized as a general purpose processor (e.g., a central processing unit (CPU), a microprocessor, a controller, etc.), a graphics processing unit (GPU), a derivative thereof, and so forth. Media 908 may be any available media that is included as part of and/or accessible by device 902. It includes volatile and non-volatile media, removable and non-removable media, storage and transmission media (e.g., wireless or wired communication channels), hard-coded logic media, combinations thereof, and so forth. Media 908 is tangible media when it is embodied as a manufacture and/or as a composition of matter. For example, media 908 may include an array of disks or flash memory for longer-term mass storage of processor-executable instructions 910, random access memory (RAM) for shorter-term storing of instructions that are currently being executed and/or otherwise processed, link(s) on network 914 for transmitting communications, and so forth.

As specifically illustrated, media 908 comprises at least processor-executable instructions 910. Generally, processor-executable instructions 910, when executed by processor 906, enable device 902 to perform the various functions described herein. Such functions include, but are not limited to: (i) those acts that are illustrated in flow diagrams 300, 600, and 800 (of FIGS. 3, 6, and 8, respectively); (ii) those provided by the illustrated data structures and interactions (e.g., of FIGS. 4 and 7); (iii) those of scheme 500 (of FIG. 5); other procedures described herein; combinations thereof; and so forth.

The devices, acts, aspects, features, functions, procedures, modules, data structures, techniques, components, parts, etc. of FIGS. 1-9 are illustrated in diagrams that are divided into multiple blocks and other elements. However, the order, interconnections, interrelationships, layout, etc. in which FIGS. 1-9 are described and/or shown are not intended to be construed as a limitation, and any number of the blocks and/or other elements can be modified, combined, rearranged, augmented, omitted, etc. in any manner to implement one or more systems, methods, devices, procedures, media, apparatuses, arrangements, etc. for specific metadata exposure with digital images.

Although systems, media, devices, methods, procedures, apparatuses, mechanisms, schemes, approaches, processes, arrangements, and other example embodiments have been described in language specific to structural, logical, algorithmic, and functional features and/or diagrams, it is to be understood that the invention defined in the appended claims is not necessarily limited to the specific features or acts described above. Rather, the specific features and acts described above are disclosed as example forms of implementing the claims.

What is claimed is:

1. One or more processor-accessible media comprising processor-executable instructions that comprise:
a browser to process a page of information, the page of information including an image item and an image metadata application programming interface (API) call; the image item comprising image data and image metadata, the image metadata API call pertaining to the image item and referencing a metadata type identification tag; the browser including an image metadata API to receive the image metadata API call; the browser to ascertain an image metadata value that is associated with the metadata type identification tag from the image metadata of the image item; the image metadata API to respond to the image metadata API call with the associated image metadata value.

2. The one or more processor-accessible media as recited in claim 1, wherein the image metadata API is to receive a second image metadata API call pertaining to the image item and referencing a second metadata type identification tag and a new image metadata value, the second image metadata API call comprising a write image metadata API call; the browser to insert into the image metadata of the image item the new image metadata value in association with the second metadata type identification tag.

3. The one or more processor-accessible media as recited in claim 1, wherein the image metadata API is to receive a second image metadata API call pertaining to the image item and referencing a second metadata type identification tag, the browser to respond with an error message if the second metadata type identification tag is not located in the image metadata of the image item.

4. The one or more processor-accessible media as recited in claim 1, wherein the browser is to cause a presented image corresponding to the image data and presented image metadata corresponding to the image metadata to be presented in a browser window, the presented image metadata including the associated image metadata value.

5. The one or more processor-accessible media as recited in claim 1, wherein the browser is to cause a presented image corresponding to the image data and presented image metadata corresponding to the image metadata to be presented in a browser window, the presented image metadata including those image metadata values that are associated with each given metadata type identification tag that is referenced in a given image metadata API call while excluding other image metadata values of the image metadata.

6. The one or more processor-accessible media as recited in claim 1, wherein the browser includes an image decoder that is to process the image item.

7. The one or more processor-accessible media as recited in claim 1, wherein the browser comprises a web browser; and the web browser is to enable a user to copy a particular image item from a website page, the copied particular image item to include the particular image data and the particular image metadata of the particular image item of the website page.

8. A method comprising:
receiving at a browser from a script an image metadata application programming interface (API) call that references a metadata type identification tag and that pertains to a targeted image item, the targeted image item comprising image data and image metadata;
ascertaining by the browser from the image metadata of the targeted image item an image metadata value that is associated with the metadata type identification tag; and
sending from the browser to the script an image metadata API response that includes the ascertained image metadata value that is associated with the metadata type identification tag of the image metadata of the targeted image item.

9. The method as recited in claim 8, wherein the act of ascertaining comprises:
ascertaining the image metadata value that is associated with the metadata type identification tag using image metadata that is part of a markup language image element, the markup language image element corresponding to the targeted image item.

10. The method as recited in claim 8, wherein the act of ascertaining comprises:
ascertaining the image metadata value that is associated with the metadata type identification tag using image metadata that is part of a property attribute or method of an image object of a document object model (DOM), the image object corresponding to the targeted image item.

11. The method as recited in claim 8, wherein the method further comprises:
receiving at the browser from the script a second image metadata API call that references a second metadata type identification tag and that pertains to the targeted image item;
ascertaining by the browser that the image metadata of the targeted image item lacks the second metadata type identification tag; and
sending from the browser to the script a second image metadata API response indicating that the second metadata type identification tag was not located in the image metadata of the targeted image item.

12. The method as recited in claim 8, wherein the method further comprises:
receiving at the browser from the script a second image metadata API call (i) that references a second metadata type identification tag and includes a new image metadata value, (ii) that pertains to the targeted image item, and (iii) that relates to a write operation;
locating by the browser a mapping association entry corresponding to the second metadata type identification tag in the image metadata of the targeted image item; and
inserting by the browser the new image metadata value in association with the second metadata type identification tag at the located mapping association entry.

13. The method as recited in claim 8, wherein the method further comprises:
causing by the browser a presented image corresponding to the image data of the targeted image item and presented image metadata corresponding to the ascertained image metadata value to be included within a browser window.

14. The method as recited in claim 8, wherein the method further comprises:
receiving at the browser form the script a second image metadata API call that references a second metadata type identification tag and that pertains to a second targeted image item, the second targeted image item comprising second image data and second image metadata;
ascertaining by the browser from the second image metadata of the second targeted image item a second image metadata value that is associated with the second metadata type identification tag; and
sending from the browser to the script a second image metadata API response that includes the ascertained second image metadata value that is associated with the second metadata type identification tag of the second image metadata of the second targeted image item.

15. A device comprising:
a page of information comprising a markup language portion and a script portion, wherein:
the markup language portion includes an image item having image data and image metadata, the image metadata associating respective image metadata values with respective metadata type identification tags, with the image metadata including a particular image metadata value that is associated with a particular metadata type identification tag; and
the script portion includes an image metadata application programming interface (API) call that pertains to the image item and references the particular metadata type identification tag; and
a browser to receive the image metadata API call and to ascertain the particular image metadata value from the image metadata using the particular metadata type identification tag; the browser to cause the particular image metadata value to be presented in response to receiving the image metadata API call.

16. The device as recited in claim 15, wherein the browser is to send to the script portion an image metadata API response including the particular image metadata value.

17. The device as recited in claim 15, wherein the browser is to parse the markup language portion to produce a document object model (DOM) of the page of information.

18. The device as recited in claim 15, wherein the browser is to include in presented image metadata of a browser window those image metadata values of the image metadata of the image item that are associated with metadata type identification tags that are referenced by the script portion in one or more image metadata API calls while excluding from the presented image metadata those image metadata values of the image metadata that are not referenced by a metadata type identification tag in at least one image metadata API call.

19. The device as recited in claim 15, wherein:
the image metadata of the image item includes a second image metadata value that is associated with a second metadata type identification tag;
the script portion includes a second image metadata API call that pertains to the image item, references the second metadata type identification tag, and includes a new second image metadata value; the second image metadata API call comprising a write API call; and
the browser is to receive the second image metadata API call and is to replace the second image metadata value with the new second image metadata value in a mapping association entry that corresponds to the second metadata type identification tag of the image metadata.

20. The device as recited in claim 15, wherein:
the script portion includes a second image metadata API call that pertains to the image item and references a second metadata type identification tag; and
the browser is to receive the second image metadata API call and is to return an error message to the script portion if the second metadata type identification tag is not located in the image metadata of the image item.
